(19) United States
(12) Patent Application Publication
(10) Pub. No.: US 2007/0135567 A1
(43) Pub. Date: Jun. 14, 2007

(54) Self crosslinking waterborne coatings

(76) Inventors: Philip J. Ruhoff, Shaker Heights, OH (US); Lynn O. Sabo, Strongsville, OH (US); Janice K. Dreshar, Westlake, OH (US); Peter J. Mackulin, North Olmsted, OH (US); John M. Krajnik, Shaker Heights, OH (US)

Correspondence Address: Robert E. McDonald, Esq.;The Sherwin-Williams Company - Legal Dept., 101 Prospect Avenue, N.W., Cleveland, OH, 44115, US

(21) Appl. No.: 11/246,929

(22) Filed: Oct. 7, 2005

Related U.S. Application Data
(60) Provisional application No. 60/617,450, filed on Oct. 8, 2004.

(51) Int. Cl. C08L 33/00; B32B 27/00

(52) U.S. Cl. 525/55; 525/191

(57) ABSTRACT

An aqueous coating composition comprising (i) a binder resin having latent crosslinking functionality, (ii) a crosslink for the resin, and (iii) polymeric extender particles is disclosed.

This invention claims the benefit of U.S. provisional application 60/617,450 filed on Oct. 8, 2004, the entirety of which is hereby incorporated by reference.

This invention relates to waterborne coatings having improved performance properties. Conventional latex paints are widely used because they provide reduced volatile organic compound emission and because they allow easier clean up than solvent borne coatings. However, when compared to solvent borne coating systems, typical latex coatings may lack certain performance properties, such as the chemical resistance and durability provided by such solvent borne coatings.

It has now been found that latex coating compositions having improved properties, such as improved stain and chemical resistance and durability, can be produced by formulating a chemical coating comprising a binder resin having post crosslinking groups; a suitable crosslinker for the binder resin; and polymeric extender particles such as polyvinyl chloride extender particles.

The present invention is directed to an aqueous coating composition in which the binder resin has functional groups that further react with one or more co-dispersed crosslinkers some time after initial formation of the binder resin. In certain applications the substantive crosslinking will be delayed until application of the coating to a substrate and evaporation of at least some of the aqueous carrier.

As reactive elements, the aqueous coating composition contains (a) a binder resin comprising the polymerization reaction product of at least one or more copolymerizable monoethylenically unsaturated monomers, wherein at least one of the monoethylenically unsaturated monomers contains latent crosslinking functionality; and (b) a crosslinking amount of at least one crosslinker reactive with the crosslinking functionality. As a coating, this invention comprises the crosslinkable binder resin, the crosslinker, and polymeric extender particles.

The latent crosslinking functionality can be imparted to the binder resin by incorporating monomers having reactive functional groups known in the art. For example (i) the pendent functional group could be a carbonyl group, such as ketone, or aldehyde, or acetoacetoxy and the crosslinker could representatively have amino or hydrazide groups; (ii) the pendent functional group could be epoxy and the crosslinker could representatively have carboxylic acid, thiol or amino groups; (iii) the pendent functional group could be silane and the crosslinker could representatively have hydroxyl groups; and (iv) the pendent functional groups could be hydroxyl groups and the crosslinker could representatively have isocyanate groups or methylol groups or etherified methylol groups.

Alternatively, the functional groups identified as useful in the crosslinkers could be incorporated into the binder resin and the corresponding identified reactive group could be present in the crosslinker. The exact nature of the coreactive groups is not critical. Any coreactive groups are possible as pendent functional groups and crosslinking groups, provided the coating composition remains fluid until application to a substrate. If desired, the crosslinker can be withheld from the coating composition until immediately prior to application to ensure that the coating composition remains fluid. In some embodiments, such as the use of pendent carbonyl groups on the binder resin, and the use of a water-soluble polyhydrazide, it is convenient to incorporate the hydrazide into the aqueous coating to provide a single package which will cure upon application.

### Binder Resins

The latex polymers used as binder resins in accordance with the present invention (also referred to herein as “binders”) include those polymers polymerized from one or more suitable monomers. Typically, the binders are polymerized from one or more copolymerizable monoethylenically unsaturated monomers such as, for example, vinyl monomers and/or acrylic monomers.

The vinyl monomers suitable for use in accordance with the present invention include any compounds having vinyl functionality, i.e., ethylenic unsaturation, exclusive of compounds having acrylic functionality, e.g., acrylic acid, methacrylic acid, esters of such acids, acrylonitrile and acrylamides. Preferably, the vinyl monomers are selected from the group consisting of vinyl esters, vinyl aromatic hydrocarbons, vinyl aliphatic hydrocarbons, vinyl alkyl ethers and mixtures thereof.

Suitable vinyl monomers include vinyl esters, such as, for example, vinyl propionate, vinyl laurate, vinyl pivalate, vinyl nonanoate, vinyl decanoate, vinyl neodecanoate, vinyl butyrates, vinyl benzoates, vinyl isopropyl acetates and similar vinyl esters; vinyl aromatic hydrocarbons, such as, for example, styrene, methyl styrenes and similar lower alkyl styrenes, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3 butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

The acrylic monomers suitable for use in accordance with the present invention comprise any compounds having acrylic functionality. Preferred acrylic monomers are selected from the group consisting of alkyl acrylates, alkyl methacrylates, acrylate acids and methacrylate acids as well as aromatic derivatives of acrylic and methacrylic acid, acrylamides and acrylonitrile. Typically, the alkyl acrylate and methacrylic monomers (also referred to herein as “alkyl esters of acrylic or methacrylic acid”) will have an alkyl ester portion containing from 1 to about 18, preferably about 1 to 8, carbon atoms per molecule.

Suitable acrylic monomers include, for example, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, benzyl acrylate and methacrylate, isobornyl acrylate and methacrylate, neopentyl acrylate and methacrylate, and 1-adamantyl methacrylate.

In addition to the specific monomers described above, those skilled in the art will recognize that other monomers such as, for example, allylic monomers, or monomers which impart wet adhesion, such as monomers having teritiary amine, ethylene ureido, or N-heterocyclic groups, can be used in place of, or in addition to, the specifically described monomers in the preparation of the binders. Representative wet adhesion promoting monomers include methacrylamidoethyl ethylene urea, dimethylaminoethyl methacrylate, vinyl imidizole and 2-ethyleneuriedo-ethyl methacrylate. The amount of such other monomers is dependent on the particular monomers and their intended function, which amount can be determined by those skilled in the art. In one embodiment of this invention, a wet adhesion promoting monomer, if desired, could be present at levels ranging up to about 5% of the total monomer mix by weight.

The monomer mix polymerized to create the binder resin of the present invention will comprise at least one ethylenically unsaturated monomer containing “latent crosslinking” capabilities, which as used herein means a monomer which possesses the ability to further react with a crosslinker some time after initial formation of the polymer. The crosslinking reaction can occur through the application of energy, e.g., through heat or radiation. Also, drying can activate the crosslinking polymer through changes in pH, oxygen content, evaporation of solvent or carrier, or other changes that causes a reaction to occur. The particular method of achieving crosslinking in the binder polymer is not critical to the present invention. A variety of chemistries are known in the art to produce crosslinking in latexes.

Representative examples of latent crosslinking carbonyl-containing monomers include acrolein, methacrolein, diacetone acrylamide, diacetone methacrylamide, 2 butanone methacrylate, formyl styrol, diacetone acrylate, diacetone methacrylate, acetonitrile acrylate, acetoacetoxyethyl methacrylate, acetoacetoxyethyl acrylate and vinylaceto acetate. These monomers normally do not affect crosslinking until during final film formation, for example, when the aqueous polymer emulsion simultaneously contains an appropriate added amount of a reactive material such as a polyamine compound as crosslinker. Particularly suitable compounds of this type are the dihydrazides and trihydrazides of aliphatic and aromatic dicarboxylic acids of 2 to 20 carbon atoms. Polyamine compounds useful as crosslinkers for the carboxyl functional groups include those having an average of at least two carbonyl-reactive groups of the formula —NH₂ and carbonyl reactive groups derived from such groups. Examples of useful amine functional groups include R—NH₂, R—O—NH₂, R—O—N═C<, R—NH—C(═O)—O—NH₂, wherein R is alkylene, alicyclic or aryl and may be substituted. Representative useful polyamines include ethylene diamine, isophorone diamine, diethylenetriamine and dibutylenetriamine. In one embodiment of this invention it is useful to utilize polyhydrazides as the polyamine compounds. Representative useful polyhydrazides include oxalic dihydrazide, adipic dihydrazide, succinic dihydrazide, malonic dihydrazide, glutaric dihydrazide, phthalic or terephthalic dihydrazide and itaconic dihydrazide. Additionally, water-soluble hydrazines such as ethylene-1,2-dihydrazine, propylene-1,3-dihydrazine and butylene-1,4-dihydrazine can also be used as one of the crosslinking agents.

Additional building blocks which are suitable for postcrosslinking are those which contain hydrolyzable organosilicon bonds. Examples are the copolymerizable monomers methacryloyloxypropyltrimethoxysilane and vinyltrimethoxysilane.

Epoxy-, hydroxyl- and/or N-alkylol-containing monomers, for example, glycidyl acrylate, N-methylolacrylamide and -methacrylamide and monoesters of dihydric alcohols with α,β-monoethylenically unsaturated carboxylic acids of 3 to 6 carbon atoms, such as hydroxyethyl, hydroxy-n-propyl or hydroxy-n-butyl acrylate and methacrylate are also suitable for postcrosslinking. Primary or secondary amino containing acrylates or methacrylates such as t-butyl amino ethyl methacrylate are also suitable.

In one embodiment the binder resin can be obtained by the polymerization of a mixture of monomers, which mixture contains about 0.5 to about 25% by weight, based on the total weight of the polymer, of at least one monomer having latent crosslinking functionality.

In one embodiment of the present invention, the binder resin is an acid functional latex. Specific acid functional monomers suitable for use in accordance with the present invention include, for example, acrylic acid, methacrylic acid, ethacrylic acid, itaconic acid, maleic acid, dimeric acrylic acid or the anhydrides thereof. Besides carboxylic acids and anhydrides, monomers possessing other acid groups such as sulfonic or phosphoric acid groups are also useful. Representative monomers include ethylmethacrylate-2-sulfonic acid, 2-acrylamido-2-methylpropane sulfonic acid, 2-methyl-2-propenoic acid ethyl-2-phosphate ester (HEMA-phosphate), (1-phenylvinyl)-phosphonic acid, or (2-phenylvinyl)-phosphonic acid. Mixtures of acids are also practical.

For many applications, typically, the particle size of the binder resins would range from about 0.1 to 1.0 microns. The Tg of some useful representative binder resins, of the present invention would typically be from about −60 to 100° C. Binder resins having a Tg less than about 20° C. typically require less volatile organic compounds (solvents and coalescents) to form a smooth film compared to higher Tg polymers. In one useful embodiment the Tg would be less than about 10° C. In another useful embodiment the Tg is less than about 1° C. As used herein, the term “Tg” means polymer glass transition temperature.

Preparation of latex compositions is well known in the paint and coatings art. Any of the well known free-radical emulsion polymerization techniques used to formulate latex polymers can be used in the present invention. Such procedures include, for example, single feed, core-shell, and inverted core-shell procedures which produce homogeneous or structured particles.

In one useful embodiment the binder resin would be obtained by polymerizing a monomer mixture of about 1-25% by weight of a monomer having latent crosslinking functionality, 0.5 to about 15% of an acid functional monomer and about 60 to 98.5% other monomers. In another useful embodiment the monomer mixture would also comprise about 0.1 to about 10% of a wet adhesion promoting monomer. In another embodiment, the monomer mixture would comprise about 1-25% by weight of a monomer having latent crosslinking functionality, 0.5 to about 15% of an acid functional monomer, 0.1 to about 10% of a wet adhesion monomer, 1 to about 55 parts styrene, and the remainder selected from other copolymerizable monomers.

The crosslinker for reaction with the latent crosslinking functionality need only be present in an amount necessary to achieve the desired degree of cure. For many applications, the crosslinker will typically be present at a level to provide at least 0.1 equivalent for each equivalent of latent crosslinking functionality.

In one of the embodiments of this invention, the crosslinker would be present at a level to provide between about 0.2 to about 2.0 equivalents for each equivalent of latent crosslinking functionality. In some useful embodiments the crosslinker will be present at a level to provide 0.4 to about 1.2 equivalents for each equivalent of latent crosslinking functionality.

In another useful embodiment the crosslinker would be present at a level to provide about 0.4 to about 1.0 equivalent for each equivalent of latent crosslinking functionality.

The coatings of this invention will also comprise a polymeric extender particle. In one embodiment of this invention, the polymeric extender particle would comprise solid polyvinyl chloride particles. Polyvinyl chloride particles are taught in U.S. Published Application 2004/0034158 A1 (Reuter et al.).

In one embodiment of this invention, the polyvinyl chloride extender particles would have an average particle size in a range from about 5 to about 150 microns. The coating composition incorporating the polyvinyl chloride extender particles would be free of plasticizers. In the absence of plasticizers, the polyvinyl chloride extender particles remain as discrete particles in the film after the coating has cured or dried. In some embodiments, it is useful to utilize polymeric extender particles which are substantially free of any colored pigments dispersed therein.

As used herein, the term “plasticizer” means a nonaqueous, nonvolatile liquid medium that is compatible with polyvinyl chloride and when added to a coating composition containing polyvinyl chloride becomes a part of the dried film and increases film flexibility. Plasticizers, when admixed with the polyvinyl chloride would produce a gel by solubilizing the polyvinyl chloride, and ultimately a fully fused solid when the composition is heated. Examples of plasticizers include phthalic acid esters, dibasic esters, phosphoric acid esters, polyester-based plasticizers and especially dioctyl phthalate and diisononyl phthalate.

As used herein, the term “polyvinyl chloride” shall mean a homopolymer of vinyl chloride, or a copolymer of at least 80 weight percent of units derived from vinyl chloride, with up to about twenty weight percent of one or more other vinyl monomers.

As defined above, the polyvinyl chloride extender particles may be homopolymers of vinyl chloride or copolymers of at least 80 weight percent of units derived from vinyl chloride, with up to about twenty weight percent of one or more other vinyl monomers. Suitable vinyl monomers include alpha-olefins, such as ethylene and propylene; vinyl esters, such as vinyl acetate, vinyl propionate, and vinyl benzoate; vinylidene chloride; alkyl (meth)acrylates, such as methyl acrylate, lauryl acrylate, methyl methacrylate and cetyl methacrylate; vinyl aromatic monomers, such as styrene and vinyl toluene; acrylonitrile; methacrylonitrile; and maleimides, such as N-cyclohexyl maleimide, N-phenylamaleimide, or maleimide. Preferably, however, the polyvinyl chloride extender particles are vinyl chloride homopolymers. Polyvinyl chloride polymers can be prepared by suspension polymerization or other techniques as is known in the art and are commercially available from a number of suppliers. One useful polyvinyl chloride resin extender particle is Geon 217 available from Poly One Corporation.

In some useful embodiments, the polyvinyl chloride extender particles will have an average particle size greater than 3 microns. For some applications, the polyvinyl chloride extender particles have an average particle size in a range from about 5 microns to about 150 microns, and frequently in a range from about 10 microns to about 100 microns. The polyvinyl chloride extender particles are solid and remain as discrete particles in the coatings of this invention even after the coating has cured or dried.

Preferably, the polyvinyl chloride extender particles have a Fikentscher K value between about 50 and about 80, more preferably between about 60 and about 70. The Fikentscher K value is determined by solution viscosity measurements and provides a measure of molecular weight. The correlation between the Fikentscher K value and number average molecular weight (Mn) is as follows: a Fikentscher K value of 50 is roughly equal to a Mn of 28,000 and a Fikentscher K value of 80 is roughly equal to a Mn of 80,000.

The amount of polymeric extender particles in the coating composition of the present invention, on a solids basis, is typically from about 5 to about 60 weight percent, and often from about 25 to about 50 weight percent, based on the total weight of solids of the coating composition.

The coating composition of the present invention is manufactured using techniques known to those skilled in the art of manufacturing paint. The coatings of this invention may also include conventional pigments and flattening agents as well as various additives. Examples of suitable inorganic flatting agents include silicates, such as talc, and various forms of silica, such as amorphous, aerogel, diatomaceous, hydrogel and fumed silicas. Conventional pigments include titanium dioxide, zinc oxide, and other inorganic or organic pigments. The coatings of this invention also may incorporate one or more polymeric opacifying agents. The polymeric opacifiers are generally small particle size non-film forming polymerized beads which are insoluble in the coating in which they are dispersed. Typically the polymeric opacifying agents will replace some of the hiding pigments which would otherwise be incorporated into the coating. The beads may be solid or they may contain vesicles or dispersed pigments within the polymerized bead. Representative polymeric particles useful as opacifying agents include beads of polystyrene, polyacrylic, polyethylene, polyamide, poly(vinylacetate ethylene), melamine formaldehyde, urea formaldehyde, polyester and polyurethane. Representative commercially available polymeric pigments are sold under the Ropaque, Dylex (polystyrene) and Pergopak (urea formaldehyde) trademarks. If polymeric opacifying agents are incorporated they typically will comprise between about 1% and about 85% by weight of the total amount of opacifying agents and pigments. Typical additives include dispersants, preservatives, anti foaming agents, thickeners, etc. The coatings of this invention can be applied to any substrate such as wood, wallboard, metal, etc. by any application method including spraying, brushing, rolling, etc. in one embodiment the coatings are especially useful as interior or exterior paints, especially house paints.

The present invention will be better understood by reference to the following examples, which are provided for purposes of illustration only and are not to be construed as limiting the scope of the present invention.

### EXAMPLE 1

A latex polymer was prepared as follows. A reaction vessel was charged with 124.75 parts water and heated to 85° C. under a nitrogen blanket. A first mixture of 6.14 parts water, 1.39 parts surfactant (Abex EP-110, an anionic surfactant available from Rhodia), 0.082 parts 28% aqueous ammonia, and 0.30 parts ammonium persulfate was then added to the heated water. A feed mixture of 50.88 parts water, 8.08 parts Abex EP-110, 3.72 parts methacrylic acid, 1.49 parts Sipomer PAM 100 (phosphate ester of 2-hydroxyethyl methacrylate from Rhodia), 5.98 parts Rohamere 6844 (25% aqueous solution of N-(2-methacryloxyethyl)ethylene urea from Rohm Tech, Inc.), 79.05 parts 2-ethyl hexyl acrylate, 54.70 parts styrene, 3.07 parts water and 4.48 parts diacetone acrylamide was prepared, as was an initiator mixture of 0.30 parts ammonium persulfate and 15.36 parts water. The feed mixture and the initiator mixture were then simultaneously added to the heated (85° C.) reaction mixture over a period of 3 hours. Upon completion of the additions, the reaction was maintained at 85° C. for an additional hour. The reaction was then allowed to cool to 65° C. and a chase oxidizer mixture of 0.21 parts t-butyl hydroperoxide in 2.4 parts water and a chase reducer mixture of 0.15 parts isoascorbic acid, 2.40 parts water, and 0.07 parts 28% aqueous ammonia were both added over 45 minutes and the reaction was held at 65° C. for 45 minutes thereafter. The reaction was then allowed to cool to 35° C. and 0.22 parts Proxel GXL and 0.75 parts 28% aqueous ammonia were added. 1.72 parts adipic dihydrazide was pre-dissolved in 5.16 parts water by heating to 60° C. and mixing for 15 minutes, and that solution was then added to the reaction mixture over a three minute period. The reaction was mixed for an additional 15 minutes and then filtered to provide the final self-crosslinking latex mixture. The latex product had a Tg of approximately −4° C., and an NVM of 41.600%.

### EXAMPLE 2

A latex mixture could be prepared by the process as shown in Example 1 except replacing the Abex EP-110 with a comparable solids amount of Rhodafac RE610 (a nonyl-phenol ethoxylated phosphate ester from Rhodia) and the monomer mix to provide, on a weight solids basis, 4% diacetone acrylamide, 1.0% methacrylic acid, 2.2% PAM 100, 52.8% 2-ethyl hexyl acrylate, and 40% styrene. The same equivalent ratio of adipic dihydrazide as in Example 1 could be utilized.

### EXAMPLE 3

A representative flat latex coating composition could be prepared by admixing the following materials in the order shown:

| Raw Material | Parts by Weight |
|---|---|
| Self-crosslinking latex of Example 2 | 39.50 |
| Defoamer¹ | 0.20 |
| Polymeric opacifying pigment² | 9.50 |
| Water | 9.15 |
| Attapulgite clay | 0.50 |
| Hydroxyethyl cellulose thickener | 0.08 |
| Microbiocide | 0.05 |
| Surfactant³ | 1.26 |
| Nonionic surfactant⁴ | 0.20 |
| 2 amino-2-methyl-1-proponol | 0.30 |
| Defoamer¹ | 0.20 |
| Ground feldspar | 9.50 |
| Polyvinyl chloride particles⁵ | 4.00 |
| Water | 0.83 |
| Ethylene glycol | 1.10 |
| Associative thickener⁶ | 1.60 |
| Water | 0.08 |
| 20% active fungicide | 0.20 |
| Titanium dioxide slurry⁷ | 30.00 |
| Water | 0.62 |
| Defoamer¹ | 0.10 |

¹Sher-Defoam, proprietary defoamer of the assignee of this application
²Ropaque OP-96 from Rohm and Haas
³Tamol 165-A from Rohm and Haas
⁴Triton N-57 nonionic surfactant from Rohm and Haas
⁵Geon 217 from Poly One Corporation. Vinyl chloride homopolymer having an average particle size of about 35 microns
⁶Acrysol RM-2020 NPR polymer solution from Rohm and Haas
⁷R-746 from Rohm and Haas

While the invention has been shown and described with respect to particular embodiments thereof, those embodiments are for the purpose of illustration rather than limitation, and other variations and modifications of the specific embodiments herein described will be apparent to those skilled in the art, all within the intended spirit and scope of the invention. Accordingly, the invention is not to be limited in scope and effect to the specific embodiments herein described, nor in any other way that is inconsistent with the extent to which the progress in the art has been advanced by the invention.

The entire disclosures of all applications, patents and publications cited herein are hereby incorporated by reference.

What is claimed is:

1. An aqueous coating composition comprising:
(i) a binder resin having latent crosslinking functionality;
(ii) an effective crosslinking amount of a crosslinker for the binder resin;
(iii) polymeric extender particles.

2. The coating of claim 1 wherein the latent crosslinking functionality comprises carbonyl groups.

3. The coating of claim 2 wherein the crosslinking agent is selected from the group consisting of di and poly amines, di and poly hydrazides, and di and poly hydrazines and mixtures thereof.

4. The coating of claim 1 wherein the binder resin is a latex resin.

5. The coating of claim 4 wherein the latex resin is the polymerized reaction product of a mixture of monomers comprising:
(i) about 1 to about 25% by weight of a monomer having latent crosslinking functionality;
(ii) about 0.5 to about 15% by weight of an acid functional monomer;
(iii) about 60 to about 98.5% of at least one other copolymerizable monomer.

6. The coating of claim 5 wherein the monomer having latent crosslinking functionality has pendent carbonyl groups as reactive crosslinking sites.

7. The coating of claim 2 wherein the crosslinker is selected from the group consisting of di and poly amines, di and poly hydrazides, and di and poly hydrazines.

8. The coating of claim 4 wherein the latex resin is the polymerized reaction product of a mixture of monomers comprising:
(i) about 1 to about 25% by weight of a monomer having latent crosslinking functionality;
(ii) about 0.5 to about 15% by weight of an acid functional monomer;
(iii) about 0.1 to about 10% of a wet adhesion promoting monomer; and
(iv) about 50 to about 98.4% of at least one other copolymerizable monomer.

9. The coating of claim 8 wherein the monomer having latent crosslinking functionality has pendent carbonyl groups as reactive crosslinking sites.

10. The coating of claim 9 wherein the crosslinker is selected from the group consisting of di and poly amines, di and poly hydrazides, and di and poly hydrazines.

11. The coating of claim 4 wherein the latex resin is the polymerized reaction product of a mixture of monomers comprising:
(i) about 1 to about 25% by weight of a monomer having latent crosslinking functionality;
(ii) about 0.5 to about 15% by weight of an acid functional monomer;
(iii) about 0.1 to about 10% of a wet adhesion promoting monomer;
(iv) about 1 to about 55% by weight of styrene; and
(v) zero to about 98.4% by weight of at least one other copolymerizable monomer.

12. The coating of claim 1 wherein the extender particles comprise polyvinyl chloride particles.

13. The coating of claim 12 wherein the polyvinyl chloride particles have an average particle size greater than 5 microns.

14. The coating of claim 13 wherein the polyvinyl chloride particles have an average particle size of 5 to about 150 microns.

15. The coating of claim 12 wherein the polyvinyl chloride extender particles are homopolymers of vinyl chloride.

16. The coating composition of claim 1 wherein the polymeric extender particles are present at about 5 to about 60 weight percent on a solids basis of the coating composition.

17. The coating composition of claim 16 wherein the polymeric extender particles are present at a level of about 25 to about 50 weight percent on a solids basis of the coating composition.

18. The coating composition of claim 1 wherein the crosslinker is present at a level to provide at least 0.1 equivalent for each equivalent of latent crosslinking functionality.

19. The coating composition of claim 1 wherein the crosslinker is present at a level to provide about 0.2 to about 2.0 equivalents for each equivalent of latent crosslinking functionality.

20. The coating composition of claim 1 wherein the crosslinker is present at a level to provide about 0.4 to about 1.2 equivalents for each equivalent of latent crosslinking functionality.

21. A coating composition comprising:
(i) a binder resin obtained by polymerizing a monomer mixture comprising:
(a) about 1 to about 25% by weight of a monomer having carbonyl latent crosslinking functionality;
(b) about 0.5 to about 15% by weight of an acid functional monomer;
(c) about 0.1 to about 10% of a wet adhesion promoting monomer; and
(d) about 50 to about 98.4% of at least one other copolymerizable monomer.
(ii) a crosslinker selected from the group consisting of di and poly amines, di and poly hydrazides, and di and poly hydrazines;
(iii) polyvinyl chloride extender particles.
